(19) United States
(12) Patent Application Publication
(10) Pub. No.: US 2002/0185027 A1
(43) Pub. Date: Dec. 12, 2002

(54) Process for manufacturing a sleeve

(76) Inventors: Udo Drager, Speyer (DE); Karlheinz Groninger, Maintal (DE)

Correspondence Address: Lawrence P. Kessler, Patent Department, NexPress Solutions LLC, 1447 St. Paul Street, Rochester, NY, 14653-7103, US

(21) Appl. No.: 10/161,949

(22) Filed: Jun. 4, 2002

(30) Foreign Application Priority Data
Jun. 8, 2001 (DE) 101 27 911.6

(51) Int. Cl. B41C 1/00; B41N 6/00

(52) U.S. Cl. 101/401.1

(57) ABSTRACT

Replaceable sleeves of cylinders in printing machines, where a process that manufactures cost-effective thin-walled replaceable sleeves with high geometric precision. The replaceable sleeves are subjected several times to the process of extrusion and shaped to the desired precision in successive individual extrusion steps.

### FIELD OF THE INVENTION

The invention involves a process for manufacturing a sleeve for a cylinder of a printing machine.

### BACKGROUND OF THE INVENTION

Different cylinders of printing machines have coatings that perform certain functions. For example, the rubber blanket (offset blanket) cylinder, which is used especially in offset printing, and the fixing roller for fixing the printing toner on the printed material in another printing step in the printer are usually coated with an elastomer. In electrophotographic printing, the image-generating cylinder or imaging drum is often coated with an organic photoconductor, on which the latent image is stored. Of great significance for the prevention of image defects and for the quality of the printed result, for example, in electrophotographic printing is the formation of the surface of the imaging drum with high precision. Because of the wear and tear on the surface of the imaging drum, the imaging drum is replaced from time to time. The high-precision imaging drum and the maintenance expense associated with the replacement, however, is costly.

It is known to provide imaging drum with coated sleeves, whose surface assumes the image-generating task of the imaging drum. If the surface is worn, only the coated sleeve is replaced, the imaging drum stays held and continues to be used as a substrate of the sleeve. An important requirement of the coated surface of the sleeve is that it is manufactured so that it is seamless (in order to prevent printing defects in the print result) and has a high geometric precision of its surface. Seams occur during the joining of the ends of the sleeve. Additional requirements involve a low wall thickness of the sleeve and low manufacturing costs. For the seamless manufacturing, during the coating of the sleeve surface, electroforming processes or centrifugal lining processes, customary until now, have been used. The electroforming process with nickel is known. Disadvantageous in the known processes are their high costs.

### SUMMARY OF THE INVENTION

The purpose of the invention is to provide a process that manufactures thin-walled replaceable sleeves with high geometric precision of their surfaces. This purpose is achieved by the invention with the process in which a material is extruded several times for the step-by-step formation of the sleeve. With this process, the purposes of the invention are achieved in a simple way. The replaceable sleeve can be heated up during extrusion. In an especially advantageous way, the outer side of the sleeve is processed with a diamond-cutting device, whereby material is removed from the outer side of the sleeve and the surface is formed in a high-precision manner. A variation of the machining of the outer side of the sleeve is in the use of high pressure through a pressure roller, whereby the outer diameter of the sleeve is adapted. An advantageous further embodiment is in arranging the sleeve in a mold and applying high pressure onto the inner side of the sleeve, whereby the circumference of the sleeve is increased and the wall thickness of the sleeve is adapted to the desired size.

The invention and its advantages will be better understood from the ensuing detailed description of preferred embodiments, reference being made to the accompanying drawings in which like reference characters denote like parts.

### BRIEF DESCRIPTION OF THE DRAWINGS

In the detailed description of the preferred embodiment of the invention presented below, reference is made to the accompanying drawings, in which:

FIG. 1 is a diagram of the extrusion process during the extrusion of a sleeve according to this invention; and

FIG. 2 is a schematic diagram of a cross-section of a replaceable sleeve according to this invention, which is enlarged from the inside.

### DETAILED DESCRIPTION OF THE INVENTION

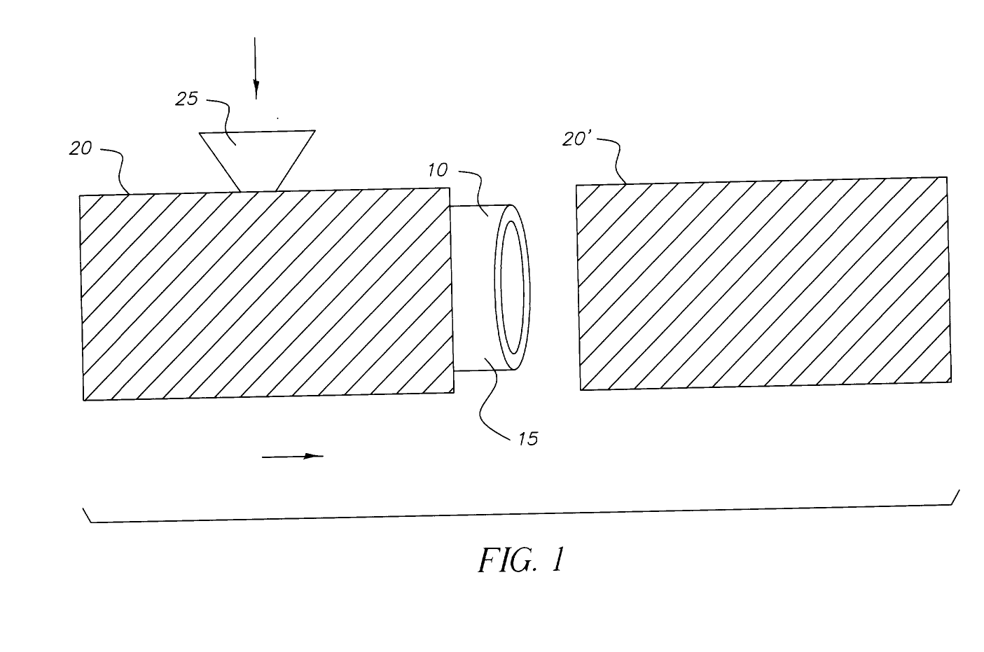

FIG. 1 shows an extrusion process of a sleeve 10 with two-barrel extruders 20, 20′. The barrel extruders 20, 20′ include a screw shape in their insides. Extruding is usually used for the shaping of ceramics or plastic. The barrel extruder 20 is supplied aluminum as a material basis for the sleeve 10 via a funnel 25, as indicated by the vertical arrow. In the barrel extruder 20, the aluminum is formed under high pressure into a pipe shape and conveyed in the direction of the horizontal arrow. In order to make the shaping process easier, the supplied aluminum is heated. The result of the extrusion process of the barrel extruder 20 is the sleeve 10 made out of aluminum with an outer wall 15, whereby the sleeve 10 is conveyed to the right out of the barrel extruder 20. After this first step, the sleeve 10 has high tolerances in relation to their outer diameter, inner diameter and the surface smoothness or surface roughness.

In a second step, the sleeve 10 is supplied to a second barrel extruder 20′. In the second barrel extruder 20′, the sleeve 10 is shaped in such a manner that the values of its outer diameter, inner diameter and the surface smoothness or surface roughness are improved in relation to the high requirements made of the sleeve 10. After leaving the barrel extruder 20′, the sleeve 10 can be used for the mounting to a cylinder of a printing machine or is supplied to another extrusion step, which further adapts the above values. As a rule, three-barrel extruders are necessary in order to suitably shape the sleeve 10 made of aluminum.

After running through the barrel extruders 20, 20′, the sleeve 10 has a wall thickness (d=rₐ−rᵢ) of the outer wall 15 of approximately 300 μm at a tolerance of 10 μm. The roughness as a measure for the surface smoothness or surface roughness is below 0.2 μm. With these intended values, the sleeve 10 can be used for different cylinder types of printing machines.

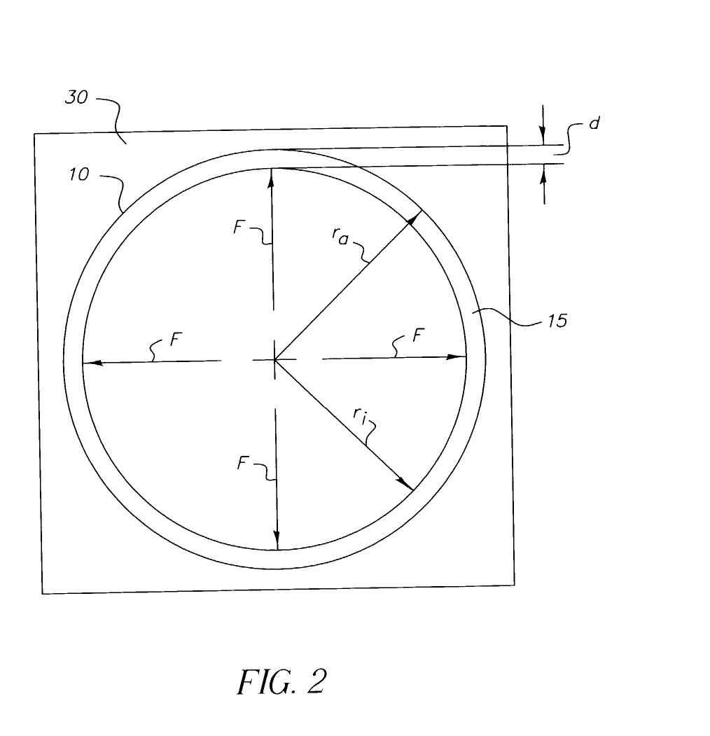

Another possibility for manufacturing consists of a process described in relation to the FIG. 2. In this process, a sleeve 10 is manufactured by extruding, which has a suitable surface smoothness or surface roughness. The inner diameter is smaller and the wall thickness d of the outer wall 15 of the sleeve 10 is larger than is necessary in the final application for a cylinder of a printing machine. The sleeve 10 is brought into a mold 30, which contains the outer surface of the sleeve 10. Next, a very high pressure is exerted on the inner side of the sleeve 10 as is shown by the force arrows F in FIG. 2. In this process, hydrogen is conducted into the inner space of the sleeve 10, and the hydrogen is expanded, whereby the force is exercised uniformly on the inner side of the sleeve 10. The outer side of the sleeve 10 presses in the process against the mold 30 in which the sleeve 10 is located. As a result of the controlled hydrogen pressure on the inner side of the sleeve 10, the wall thickness d and the inner diameter or inner radius rᵢ of the outer wall 15 of the sleeve 10 changes to the desired values. The hydrogen pressure is controlled in the process in such a way that the desired wall thickness d and inner radius rᵢ of the sleeve 10 are always obtained. An additional process step provides for the machining of the surface of the sleeve 10 with a diamond-cutting device, in order to obtain a high surface smoothness. This is commonly referred to as the well known process “diamond turning”. Of course, the methods for machining the surface of the sleeve 10, such as contact with at least one pressure roller for example, are suitable for this invention

The invention has been described in detail with particular reference to certain preferred embodiments thereof, but it will be understood that variations and modifications can be effected within the spirit and scope of the invention.

What is claimed is:

1. Process for manufacturing a sleeve (10) for a cylinder of a printing machine, characterized by a multiple extrusion of a material for step-by-step shaping of the sleeve (10).

2. Process for manufacturing a sleeve (10) for a cylinder according to claim 1, characterized by a heating of said sleeve (10) during the extrusion steps.

3. Process for manufacturing a sleeve (10) for a cylinder according to claim 1, characterized by extrusion until a desired inner diameter rᵢ of said sleeve (10) is reached, and machining of the outer side of said sleeve (10) using a diamond cutting device.

4. Process for manufacturing a sleeve for a cylinder according to claim 1, characterized by extrusion until a desired inner diameter rᵢ of said sleeve (10) is reached, and machining of the outer side of said sleeve (10) using at least one pressure roller for adapting the outer diameter rₐ of said sleeve (10).

5. Process for manufacturing a sleeve for a cylinder according to claim 1, characterized by arrangement of said sleeve (10) in a mold (30), application of a high pressure on the inner side of said sleeve (10), expansion of the circumference of said sleeve (10) in the mold (30) for adapting the wall thickness d of said sleeve (10).
